(19) United States
(12) Patent Application Publication
(10) Pub. No.: US 2025/0110853 A1
(43) Pub. Date: Apr. 3, 2025

(54) METHOD FOR AUTOMATICALLY TRANSLATING PROGRAM CODE FROM A SOURCE LANGUAGE TO A TARGET LANGUAGE

(71) Applicant: Robert Bosch GmbH, Stuttgart (DE)

(72) Inventors: Jesko Hecking-Harbusch, Leonberg (DE); Jochen Quante, Ludwigsburg (DE); Matthias Woehrle, Bietigheim-Bissingen (DE); Maximilian Schlund, Stuttgart (DE); Sebastian Ernesto Sierra Loaiza, Leipzig (DE)

(21) Appl. No.: 18/806,203

(22) Filed: Aug. 15, 2024

(30) Foreign Application Priority Data
Sep. 28, 2023 (EP) 23 20 0608.0

(51) Int. Cl. G06F 11/36; G06F 8/51; G06F 8/77

(52) U.S. Cl. CPC G06F 11/3616; G06F 8/51; G06F 8/77; G06F 11/3692

(57) ABSTRACT

A method for automatically translating program code from a source language to a target language. The method includes: translating a source program code in a source language into a target program code in a target language by means of a language model; repeating the translation with changed conditions, such as changing one or more hyperparameters such as a temperature parameter of the language model, transformations in the source program code, and/or changes in the input to the language model; comparing the source program code and the target program code or codes with a test harness, wherein the test harness is generated automatically; and evaluating the target program code based on code quality metrics, test quality metrics and/or the number of tests.

### CROSS REFERENCE

The present application claims the benefit under 35 U.S.C. § 119 of European Patent Application No. EP 23 20 0608.0 filed on Sep. 28, 2023, which is expressly incorporated herein by reference in its entirety.

### BACKGROUND INFORMATION

Methods for automatically translating program code from a source language to a target language exist.

Translation is carried out manually, for instance, i.e., by a programmer. This procedure is not efficient.

There are also dedicated code translators. However, these are only available for a few source-target language pairs. One problem is that the translations do not guarantee that the code is functional in the target language. Unreadable code may moreover be generated, that has no maintainability, for example, because the translation is mechanistic. Lastly, there is a risk that the dedicated code translator may possibly adopt the idioms of the source language and not adapt them to the target language.

Recently, attempts have been made to use large language models (LLM) or code assistants for code translation. Problems arise, however, because LLMs and code assistants do not provide guarantees for the correctness of the translated code.

### SUMMARY

A first general aspect of the present invention relates to a method for automatically translating program code from a source language to a target language.

According to an example embodiment of the present invention, the method includes:
translating a source program code in a source language into a target program code in a target language by means of a language model,
repeating the translation with changed conditions, such as changing one or more hyperparameters such as a temperature parameter of the language model, transformations in the source program code, and/or changes in the input to the language model,
comparing the source program code and the target program code or codes with a test harness, wherein the test harness is generated automatically,
evaluating the target program code based on code quality metrics, test quality metrics and/or the number of tests.

A second general aspect of the present invention relates to a method for training a language model configured to automatically translate program code from a source program code in a source language to a target program code in a target language.

According to an example embodiment of the present invention, the method includes:
inputting the source program code into a language model and generating a predictive target program code,
automatically checking the predictive target program code based on a formal check of the same behavior of the source program code and the target program code, tests in the source language, tests for contracts in the source language and/or syntactic and stylistic tests,
generating a reward for the language model, wherein a negative reward is generated if a test fails, wherein a positive reward is generated if all of the tests are successful, and wherein the amount of a value of the reward is based on the number of tests in the source language and the contracts in the source language,
updating weights of the language model with the value of the reward.

A third general aspect of the present invention relates to a computer system configured to carry out the method according to the first and/or the second general aspect (or an embodiment thereof).

A fourth general aspect of the present invention relates to a computer program configured to carry out the method according to the first general aspect (or an embodiment thereof).

A fifth general aspect of the present invention relates to a computer-readable medium or signal, which stores and/or contains the computer program according to the fourth general aspect (or an embodiment thereof).

The techniques of the first, second, third, fourth and fifth general aspects of the present invention may have one or more of the following advantages in some situations.

A symbiosis of a language model for generating code (using the creativity of the language model) and verification and validation (V&V) techniques to ensure the results of the language model is proposed. This strong or complete automation increases efficiency. The V&V techniques are used to ensure that the result is (probably) correct, to provide the user with feedback about the correctness, confidence and/or quality of the translation, and to make the code translation more reliable.

The present disclosure enables the automatically translated code to be guaranteed. The use of language models such as LLMs to translate the code makes the translated code understandable and utilizes the characteristics of the target language. The advantage is that the resulting code fulfills properties such as functional equivalence and other properties, in particular security requirements. The quality of the resulting, i.e. translated, code is measured and evaluated as well.

The present invention enables code translation that fulfills security requirements. The generated code can therefore run on security-critical systems, such as a control unit, in particular in the automotive sector.

Some terms are used in the present disclosure in the following manner:

A “language model” can in particular be a large language model (LLM), a neural network, a recurrent neural network (RNN), a transformer model, or a code model as a language model specialized for code or also a very general language model that also includes code. Also included are computer languages, codes such as program codes of a computing device such as a computer. The language of the model can include not only natural languages, but also artificial languages such as programming languages.

“Testing,” “checking” or “comparing the source program code and the target program code” can include: a formal check of the same behavior of the source program code and the target program code, for example by means of bounded model checking, tests in the source language, tests for contracts in the source language and/or syntactic and stylistic tests, fuzzing, mutation of the inputs of the test harness, derivation from contracts of the source language and/or the target language and/or derivation from a language model.

A “test harness” or test framework includes a collection of software and test data that is used to systematically and automatically test a program under different ambient conditions. A test harness typically includes a test execution engine that is responsible for executing the test logic, and a test data repository or database that contains the test scripts, test programs and other test resources. The test harness in this case is generated automatically, for example by adding differentiating tests to the database. The test can be started with specific or ready-made tests from the test database. The system can also generate tests automatically.

Data here can be software code including test cases and harnesses plus additional (natural language) descriptions of the functionality or areas of validity. As an example, C is described here as the source language and Rust as the target language; other combinations are possible. The translation of C to Rust is interesting, because Rust provides features in the area of security-critical systems, whereas other languages, especially C, include a lot of legacy code.

“Contracts” are a component of contract-based programming or design by contract. This is a concept of software development that has the objective of optimizing the interaction of individual program modules by defining formal contracts for the use of interfaces that go beyond their static definition.

“Fuzzing” or “fuzz testing” is the automated process of sending randomly generated inputs from a fuzzer to a target or target program and observing the response of the target.

A fuzzer or fuzzing engine is a program that automatically generates inputs. They are therefore not necessarily connected to the software being tested and no instrumentation is carried out. They do, however, have the ability to instrument code, generate test cases and execute programs being tested. Well-known examples are afl and libfuzzer.

A “test case” is a specific input and a specific test run from a test harness or fuzz test. To ensure reproducibility, interesting runs (finding new code paths or crashes) are stored.

### BRIEF DESCRIPTION OF THE DRAWINGS

FIG. 1 is a flow chart that illustrates the techniques of the present invention for automatically translating program code.

FIG. 2 schematically shows a system in which the techniques of the present invention for automatically translating program code can be used.

FIG. 3 schematically shows a system in which the techniques of the present invention for automatically translating program code can be used.

FIG. 4 is a flow chart that illustrates the techniques of the present invention for training a language model.

### DETAILED DESCRIPTION OF EXAMPLE EMBODIMENTS

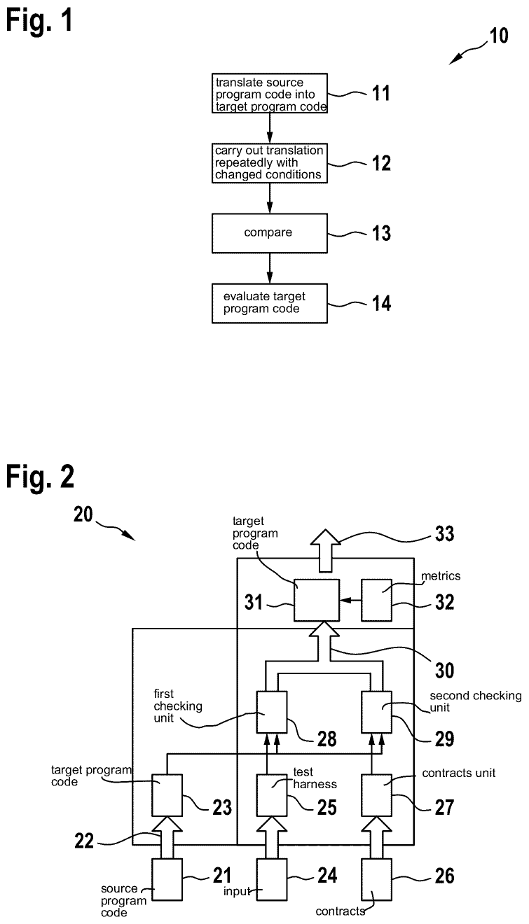

FIG. 1 is a flow chart that shows a method 10 for automatically translating program code from a source language to a target language.

In a first step, a source program code in a source language is translated 11 into a target program code in a target language by means of a language model. The language model is a large language model (LLM), for example, into which data such as, in this case, a program code is entered via input (prompt) together with a question, such as, in this case. a translation request.

The translation is carried out repeatedly 12 with changed conditions, such as changing one or more hyperparameters such as a temperature parameter of the language model, transformations in the source program code, and/or changes in the input to the language model such as changes in the tasks or prompts. Variables in the code can be renamed as well.

These measures create a variance. This variance makes it possible to verify and improve the quality evaluation of the generated translations and also train the language model with feedback. Part of the improved quality evaluation is being able to determine which of the generated translations are more or less suitable.

The source program code and the target program code or codes is then compared 13 with a test harness, in which case the test harness is generated automatically. Alternatively, it is also possible to use an already existing test harness. Tests of the test harness or the test harness itself can be generated automatically, for example by fuzzing, mutation of the inputs of the test harness, derivation from contracts of the source language and/or the target language and/or from a language model.

Comparing the target program code to the test harness can begin with one or more specified or ready-made tests, for example. These initial tests can belong to the codes or be provided with the codes. The tests can be stored in a test database. Differentiating tests can then be added to the test database.

An automatic configuration of a test harness that compares a source program code and a target program code can include the following steps or specifications:
If the comparison on given tests fails, that variant of the translation is discarded.
If the comparison on automatically generated tests fails, that variant of the translation is discarded. The failed test or tests is adopted because it is obviously differentiating. Adopting can include storing it in the test database. Automatically generated tests can result from fuzzing, mutation of the inputs, derivation from contracts and possibly from a language model.
If the comparison on differentiating tests fails, that variant is discarded.

Static checks can optionally be carried out in parallel to the tests with the test harness.
Contracts are either specified or extracted from the system environment.
In the case of Rust, contracts can also be provided by the compiler; in other languages, e.g. also by Linter, etc.
Bounded model checking and/or abstract interpretation, implemented in commercial tools such as Astrée or open source tools such as CBMC.
Automatic configuration of a bounded model checking setup that statically compares target program code against given contracts.
Automatic configuration of an abstract interpretation setup that statically compares target program code against given contracts.
Automatic configuration of a bounded model checking setup that checks source program code and target program code for functional equality.

The target program code is evaluated 14 based on code quality metrics such as the length of the source code, the number of loops and/or the branch depth, test quality metrics such as branch coverage and/or number of available or carried out tests.

According to an embodiment, the method further includes carrying out steps 11 to 14 several times so that several evaluations of target program codes are generated and the several evaluations are each provided with a quality value.

According to one embodiment, the method also includes generating the quality values based on code and test metrics, the number of available tests, the number of additionally carried out tests and/or the type and/or number of formal checks of contracts of the target language.

The evaluations or the quality values enable a comparability and prioritization of the generated target program codes. The method returns only correct solutions, i.e. code translations, and also provides information relating to quality and confidence in the correctness.

FIG. 2 schematically shows a computer system 20 in which the techniques of the present disclosure for automatically translating program code can be used. The computer system 20 is configured to carry out the method 10 according to FIG. 1 and the method 40 according to FIG. 4. Computer system 20 can be implemented in hardware and/or software. The system shown in FIG. 2 can therefore be considered a computer program that is configured to carry out the method 10 according to FIG. 1 and the method 40 according to FIG. 4.

A source program code 21 in a source language such as C is provided to a language model 22 such as a large language model (LLM) for translation into a target language such as Rust. The language model 22 generates a target program code 23 as a translation of the source program code 21. This region of the computer system 20 can be referred to as the generation region.

Tests and optionally a test harness in the source language are another input 24 to the system 20. Alternatively or optionally, the tests and/or the test harness can be in the target language. These inputs are fed to a test harness 25. The test harness 25 records functions or tests in the target language.

Contracts 26 can optionally be fed to a contracts unit 27 that operates in the target language such as Rust. The contracts are managed there for later checks of the target program code 23.

Inputs of a first checking unit 28 are connected to the language model 22 for inputting the target program code 23 and with the test harness 25 for inputting test routines. In the first checking unit 28, the target program code 23 is compared to the source program code 21 by means of the test harness 25.

Inputs of a second checking unit 29 are connected to the language model 22 for inputting the target program code 23 and to the contracts unit 27 for inputting contracts. In the second checking unit 29, the source program code 21 is checked using the contracts 26.

If the checks in the first checking unit 28 and in the second checking unit 29 are completed successfully, a status message 30 indicating that the target program code 23 is okay is output. This region of the computer system 20 can be referred to as the checking region.

The target program code 31 is evaluated in terms of its quality using metrics 32. The metrics 32 can include code quality metrics, test quality metrics, and/or the number of tests. If the evaluation is successful, the target program code and its quality are output as the output 33. This region of the computer system 20 can be referred to as the quality evaluation region.

A quality can be calculated on the basis of the evaluation. If several target program codes have been generated, the solutions can be provided to the user in order of quality.

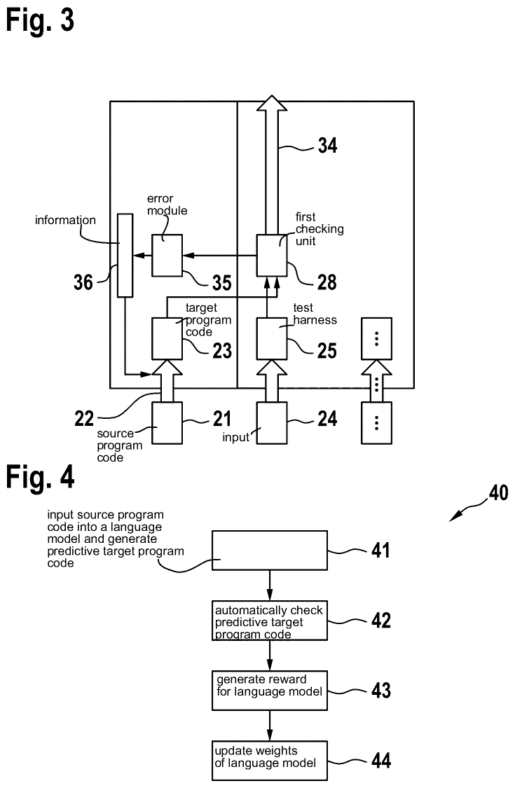

FIG. 3 schematically shows a computer system 20 in which the techniques of the present disclosure for automatically translating program code can be used. The computer system 20 can be the same as the computer system 20 of FIG. 2. The computer system 20 is configured to carry out the method 10 according to FIG. 1 and the method 40 according to FIG. 4, the computer system 20 of FIG. 3 is in particular configured to carry out the training method 40 according to FIG. 4. Computer system 20 can be implemented in hardware and/or software. The system shown in FIG. 3 can therefore be considered a computer program that is configured to carry out the method 10 according to FIG. 1 and the method 40 according to FIG. 4.

FIG. 3 shows an error handling mechanism of the computer system 20. If no target program code 31 without errors can be generated, an error results in the first checking unit 28. A message 34 to reduce confidence in the translation is then output. The error and the associated target program code 31 are moreover stored in an error module 35.

From the error module 35, the best target program code to date with the errors that still exist is fed back to the language model 22 as information 36 to be used to generate a better, ideally error-free target program code. This reduces the reliability and is taken into account in the quality determination.

This can optionally refer not only to errors in the checking region, but analogously also to errors in the quality evaluation region.

FIG. 4 is a flow chart that illustrates a method 40 for training a language model. The method 40 for training a language model is configured to automatically translate program code from a source program code in a source language to a target program code in a target language.

In a first step, the source program code is input 41 into a language model and a predictive target program code is generated. The language model can already be pretrained and possibly also already fine-tuned. Alternatively, it is also possible to start with a new, untrained language model. The training here is based on reinforcement learning. Training takes place in a training environment, for example with PPO (proximal policy optimization).

The predictive target program code is furthermore checked automatically 42 based on a formal check of the same behavior of the source program code and the target program code, tests in the source language, tests for contracts in the source language and/or syntactic and stylistic tests.

This is followed by the generation 43 of a reward for the language model, wherein a negative reward is generated if a test fails. The value of the negative reward becomes more negative the more incorrect the check or the result thereof is. A positive reward is generated if all of the tests and the amount of a value of the reward is based on the number of tests in the source language and the contracts in the source language.

According to one embodiment, the method further includes that the value of the reward is offset against a code quality metric in the case of a positive reward.

Lastly, the weights of the language model are updated 44 with the value of the reward. The result of the method is a language model that is better trained on new unlabeled data (here, for example C code from an engine control system), i.e. provides more reliable translations.

According to one example embodiment of the present invention, the method also includes approximating the reward by carrying out only one test of the automatic checking tests. This makes it possible to accelerate the training.

What is claimed is:

1. A method for automatically translating program code from a source language to a target language, comprising the following steps:
translating a source program code in a source language into a target program code in a target language using a language model;
repeating the translation with changed conditions;
comparing the source program code and at least one of the target program codes using a test harness, wherein the test harness is generated automatically; and
evaluating the at least one of the target program codes based on code quality metrics and/or test quality metrics and/or number of tests.

2. The method according to claim 1, wherein the changed conditions include one or more of: (i) changing one or more hyperparameters of the language model, (ii) changing a temperature parameter of the language model, (iii) transformations in the source program code, (iv) changes in an input to the language model.

3. The method according to claim 1, wherein the steps of the method are carried out several times so that several evaluations of target program codes are generated and wherein the several evaluations are each provided with a quality value.

4. The method according to claim 3, wherein the quality values are generated based on at least one of: (i) code and test metrics, (ii) a number of available tests, (iii) a number of additionally carried out tests, (iv) a type and/or number of formal checks of contracts of the target language.

5. The method according to claim 1, wherein the changed conditions of translating include: (i) renaming variables in the code and/or (ii) changing tasks and/or (iii) changing commands in an input to the language model.

6. The method according to claim 1, wherein tests of the test harness are generated automatically by fuzzing, and/or mutation of inputs of the test harness, and/or derivation from contracts of the source language and/or derivations from contracts of the target language and/or derivation from a language model.

7. The method according to claim 1, wherein, in the event of an unsuccessful comparison and/or evaluation, information about errors in the at least one translated program code is fed back to the language model.

8. A method for training a language model configured to automatically translate program code from a source program code in a source language to a target program code in a target language, the method comprising the following steps:
inputting the source program code into a language model and generating a predictive target program code;
automatically checking the predictive target program code based on: (i) a formal check of a same behavior of the source program code and the predictive target program code, and/or (ii) tests in the source language and/or (iii) tests for contracts in the source language and/or (iv) syntactic and stylistic tests
generating a reward for the language model, wherein a negative reward is generated when a test fails, wherein a positive reward is generated when all of the tests are successful, and wherein an amount of a value of the reward is based on a number of tests in the source language and the contracts in the source language; and
updating weights of the language model with the value of the reward.

9. The method according to claim 8, wherein the value of the reward is offset against a code quality metric in the case of a positive reward.

10. The method according to claim 8, wherein the reward is approximated by carrying out only one test of the automatic checking tests.

11. A computer system configured to automatically translate program code from a source language to a target language, the computer system configured to:
translate a source program code in a source language into a target program code in a target language using a language model;
repeat the translation with changed conditions;
compare the source program code and at least one of the target program codes using a test harness, wherein the test harness is generated automatically; and
evaluate the at least one of the target program codes based on code quality metrics and/or test quality metrics and/or number of tests.

12. A non-transitory computer-readable medium on which is stored a computer program automatically translating program code from a source language to a target language, the computer program, when executed by a computer, causing the computer to perform the following steps:
translating a source program code in a source language into a target program code in a target language using a language model;
repeating the translation with changed conditions;
comparing the source program code and at least one of the target program codes using a test harness, wherein the test harness is generated automatically; and
evaluating the at least one of the target program codes based on code quality metrics and/or test quality metrics and/or number of tests.
